(19) United States
(12) Patent Application Publication
(10) Pub. No.: US 2006/0154044 A1
(43) Pub. Date: Jul. 13, 2006

(54) Anti-reflection coating and optical element having such anti-reflection coating for image sensors

(75) Inventors: Kazuhiro Yamada, Saitama-ken (JP); Yasuhiro Sakai, Saitama-ken (JP); Hiroyuki Nakayama, Tokyo (JP); Maki Yamada, Saitama-ken (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 11/324,312

(22) Filed: Jan. 4, 2006

(30) Foreign Application Priority Data
Jan. 7, 2005 (JP) 2005-002774

(51) Int. Cl. B32B 3/26; B32B 7/02

(52) U.S. Cl. 428/312.2; 428/212

(57) ABSTRACT

An anti-reflection coating having a luminous reflectance of 2% or less to light at an incident angle of 0-60° and excellent scratch resistance, which comprises a dense layer and a porous silica aerogel layer formed in this order on a substrate such that a refractive index successively decreases from said substrate to said porous layer.

### FIELD OF THE INVENTION

The present invention relates to an anti-reflection coating formed on a substrate, particularly to an anti-reflection coating having excellent anti-reflection characteristics to a wide-incident-angle light in a wide wavelength range, and an optical element having such anti-reflection coating for image sensors.

### BACKGROUND OF THE INVENTION

To improve transmittance, a substrate such as a lens, a prism, etc. constituting optical equipment is provided with an anti-reflection coating. The suppression of reflection in a visible range by an anti-reflection coating improves the clarity and visibility of image. Because many optical equipments are intended to use lights in narrow wavelength ranges, the anti-reflection coatings formed on optical elements are designed to exhibit excellent anti-reflection effects in wavelengths used. For instance, a single-layer anti-reflection coating is designed to have such thickness that an optical path difference between light reflected from a surface of the anti-reflection coating and light reflected from an interface between the anti-reflection coating and a lens is in an odd multiplication of half a wavelength, resulting in cancellation of these lights by interference.

However, because optical equipments using wide-wavelength light are recently manufactured, demand is mounting for anti-reflection coatings having excellent optical properties in a wide wavelength range. Also, because many optical elements are constituted by pluralities of lenses, multi-layer anti-reflection coatings are generally used to prevent reflection on each lens surface from decreasing transmitted light. The multi-layer anti-reflection coatings are designed such that light reflected from each layer boundary and incident light to each layer are cancelled by interference.

Lenses used in optical systems for image sensors in cameras, etc. have recently come to have high numerical apertures (NA) by the demand of miniaturization and higher performance. However, for instance, the larger numerical aperture an objective lens of a camera has, the larger curvature it has, resulting in a large incident angle of light in a peripheral portion of the lens. Accordingly, there is a large amount of reflected light in the peripheral portion of a lens, resulting in differences in the amount and color of transmitted light between the center and peripheral portions of the lens, and ghost generated due to light reflected from the peripheral portion of the lens. It is thus desired to provide an anti-reflection coating having excellent properties to wide-incident-angle light.

An anti-reflection coating formed on a curved surface of a convex lens, etc. by a physical film-forming method generally tends to be thinner in a peripheral portion than in a center portion. Accordingly, spectral properties in a peripheral portion of the lens are shifted from the designed target toward a shorter wavelength side, resulting in a larger amount of reflected light particularly in a red color range. Further, slant incident light is used in the peripheral portion of the lens unlike in the center portion, resulting in further shift of spectral properties toward the shorter wavelength side because interference length becomes shorter as an incident angle increases. It is also desired from this point to provide an anti-reflection coating having excellent anti-reflection characteristics to a wide-incident-angle light.

In such circumstances, JP 2003-43202A proposes an anti-reflection coating comprising first and eighth low-refractive-index layers, second, fourth and sixth intermediate-refractive-index layers, and third, fifth and seventh high-refractive-index layers from the substrate side, the optical thickness nd of each layer relative to the designed wavelength λd being (0.9-2.4)×λd/4 in the first layer, (0.9-1.2)×λd/4 in the second layer, (0.27-0.50)×λd/4 in the third layer, (0.17-0.27)×λd/4 in the fourth layer, (1.34-2.14)×λd/4 in the fifth layer, (0.35-0.45)×λd/4 in the sixth layer, (0.26-0.38)×λd/4 in the seventh layer, and (1.03-1.13)×λd/4 in the eighth layer. This anti-reflection coating exhibits less than 1.0% of reflectance to light having a wavelength of 340-900 nm. However, it has insufficient anti-reflection characteristics to a high-incident-angle light. For instance, luminous reflectance [Y value determined from spectral reflectance according to the XYZ color system of the International Commission on Illumination (CIE)] to light having an incident angle of 60° is more than 4%.

JP 10-227902A proposes a wide-band anti-reflection coating comprising at least two fluororesin layers, a high-refractive-index layer and a low-refractive-index layer from the substrate side. This wide-band anti-reflection coating exhibits transmittance of 99.5% or more in a wavelength range of 350-1350 nm. This wide-band anti-reflection coating also shows high anti-reflection performance to visible light having a relatively high incident angle. For instance, it has luminous reflectance of about 1.6% to light having an incident angle of 60°. However, the anti-reflection coating made of a fluororesin does not have sufficient mechanical strength to withstand practical use.

JP 2003-119052A proposes a light-transmitting sheet having a silica aerogel layer formed on one surface of a light-transmitting sheet body. Because the silica aerogel has as low a refractive index as 1.35 or less, the light-transmitting sheet of JP 2003-119052A has excellent anti-reflection characteristics. JP 2003-119052A also describes that pluralities of silica aerogel layers are formed such that a layer closer to the sheet body has a higher refractive index. However, because the optical thickness of each layer is not optimized to incident light in this light-transmitting sheet, it does not necessarily have high anti-reflection characteristics to light in a wide incident angle range.

### OBJECT OF THE INVENTION

Accordingly, an object of the present invention is to provide an anti-reflection coating having excellent anti-reflection characteristics to a wide-incident-angle light in a wide wavelength range, and having sufficient mechanical strength, and an optical element having such anti-reflection coating for image sensors.

### DISCLOSURE OF THE INVENTION

As a result of intense research in view of the above objects, it has been found that when a dense layer and a porous silica aerogel layer are formed in this order on a substrate such that a refractive index decreases from said substrate side, it is possible to provide an anti-reflection coating having excellent anti-reflection characteristics to a wide-incident-angle light in a wide wavelength range, and sufficient mechanical strength. The present invention has been completed based on this finding.

Thus, the anti-reflection coating of the present invention comprises a dense layer and a porous silica aerogel layer formed in this order on a substrate such that a refractive index successively decreases from said substrate to said porous layer.

Said dense layer is preferably an inorganic layer, a fine inorganic particles-binder composite layer or a resin layer. Said inorganic layer is preferably formed by a vapor deposition method. Said vapor-deposited inorganic layer is preferably made of magnesium fluoride or silicon oxide.

Said porous silica aerogel layer is preferably formed by heat-treating an organic-modified silica aerogel layer. Said porous silica aerogel layer preferably has a refractive index of 1.05-1.35. Said porous silica aerogel layer preferably has a porosity of 30-90%. Said porous silica aerogel layer preferably has a contact angle of 150 or less to pure water.

It is preferable that said dense layer and said porous silica aerogel layer respectively have optical thickness in a range of λd/5-λd/3, wherein λd is a designed wavelength. The anti-reflection coating of the present invention preferably has a luminous reflectance of 2% or less to light at an incident angle of 0-600 in a wavelength range of the designed wavelength±100 nm.

The anti-reflection coating of the present invention comprises an anti-reflection coating comprising a dense layer and a porous silica aerogel layer formed in this order on a substrate such that a refractive index successively decreases from said substrate to said porous layer.

### BRIEF DESCRIPTION OF THE DRAWINGS

FIG. 1 is a cross-sectional view showing one example of optical elements for image sensors, which has the anti-reflection coating of the present invention.

FIG. 2 is a graph showing the relation between the optical thickness and refractive index of the anti-reflection coating of the present invention.

FIG. 3 is a graph showing the spectral reflectance of a multi-layer anti-reflection coating in Example 1.

FIG. 4 is a graph showing the spectral reflectance of a multi-layer anti-reflection coating in Example 2.

FIG. 5 is a graph showing the spectral reflectance of a dense, multi-layer anti-reflection coating in Comparative Example 1.

FIG. 6 is a graph showing the spectral reflectance of a dense, multi-layer anti-reflection coating in Comparative Example 2.

FIG. 7 is a graph showing the spectral reflectance of a dense, multi-layer anti-reflection coating in Comparative Example 3.

### DESCRIPTION OF THE PREFERRED EMBODIMENTS

Optical Element Having Anti-Reflection Coating for Image Sensors

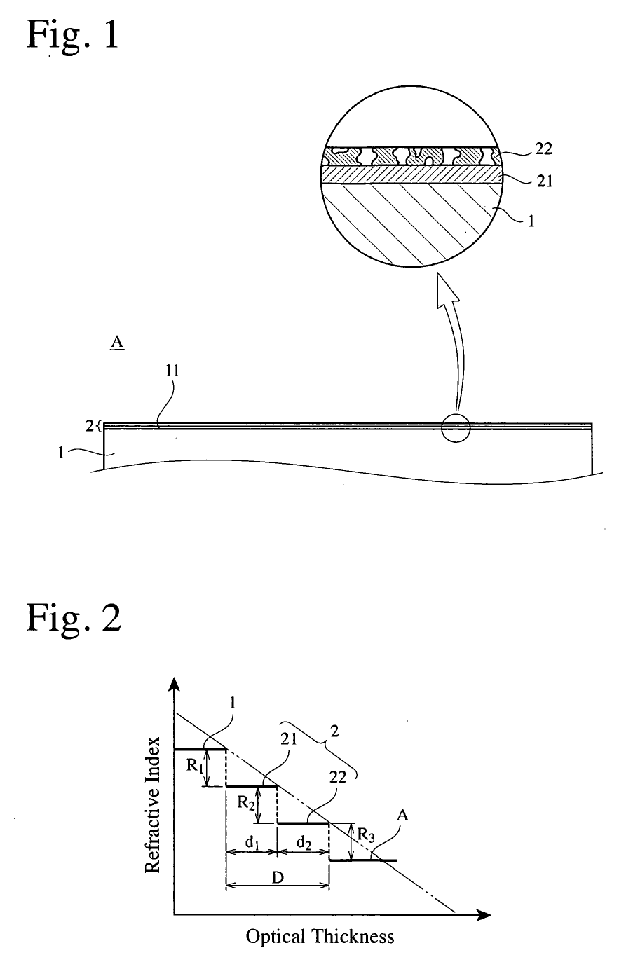

FIG. 1 shows an anti-reflection coating 2 formed on a surface 11 of an optical substrate (simply called “substrate”) 1. As shown in FIG. 1, the anti-reflection coating 2 comprises two layers, a dense layer 21 and a porous silica aerogel layer 22, in this order from the side of the substrate 1. Though a flat plate is used as the substrate 1 in the example shown in FIG. 1, the present invention is not restricted thereto, but may be applied to substrates such as lenses, prisms, light guides, films or diffraction elements. The substrate 1 may be made of materials such as glass, crystalline materials or plastics. Specific examples of materials for the substrate 1 may be optical glass such as BK7, LASF016, LAK14 and SF5, Pyrex® glass, quartz, blue sheet glass, white sheet glass, acrylic resins such as PMMA, polycarbonates, polyolefins, etc. These materials have refractive indexes of 1.45 to 1.85.

The refractive index successively decreases from the substrate 1 to the dense layer 21, to the porous silica aerogel layer 22 and to an incident medium A. The dense layer 21 and the porous silica aerogel layer 22 have optical thickness d₁, d₂ within a range of λd/5−λd/3, wherein λd is a designed wavelength. The “optical thickness” is a product of the refractive index and physical thickness of a film. Though the “designed wavelength λd,” which is used to determine the structure of a thin film, may be appropriately set depending on a wavelength intended to use for an optical element having the anti-reflection coating, it is preferably a substantially center wavelength of a visible range of 380-780 nm according to the definition of the International Commission on Illumination (CIE).

The anti-reflection coating 2 comprising two layers, a dense layer 21 and a porous silica aerogel layer 22, are formed such that a refractive index successively decreases from the substrate 1 to the porous layer 22. When the optical thickness of each layer 21, 22 is within a range of λd/5−λd/3, wherein λd is a designed wavelength, the optical thickness D of the anti-reflection coating 2 (sum of the optical thickness d₁ and d₂) is within a range of 2λd/5−2λd/3, and the refractive index changes with the optical thickness smoothly and stepwise from the substrate 1 to the incident medium A as shown in FIG. 2. When the optical thickness D of the anti-reflection coating 2 is within a range of 2λd/5−2λd/3, optical path difference between light reflected from a surface of the anti-reflection coating 2 and light reflected from a boundary between the anti-reflection coating 2 and the substrate 1 is substantially ½ of the designed wavelength λd, so that these lights are cancelled by interference. Smooth and stepwise change of a refractive index relative to optical thickness from the substrate 1 to the incident medium A reduces the reflection of incident light at layer boundaries in a wide wavelength range. Further, light reflected from layer boundaries cancels light entering into each layer by interference. Accordingly, the anti-reflection coating 2 exhibits an excellent anti-reflection effect to wide-incident-angle light in a wide wavelength range. If the optical thickness of each layer 21, 22 is outside the range of λd/5−λd/3, there is no smooth change in the refractive index with the optical thickness from the substrate 1 to the incident medium A, resulting in large reflectance at the boundaries of the two layers 21, 22. Each optical thickness d₁ and d₂ of the dense layer 21 and the porous silica aerogel layer 22 is more preferably λd/4.5−λd/3.5.

Refractive index differences R₁, R₂ and R₃ between the substrate 1 and the dense layer 21, between the dense layer 21 and the porous silica aerogel layer 22, and between the porous silica aerogel layer 22 and the incident medium A are preferably 0.02-0.4, such that the change of the refractive index with the optical thickness is as smooth as substantially close to a straight line, to improve the anti-reflection effect of the anti-reflection coating 2.

The dense layer 21 may be a layer of an inorganic material such as a metal oxide, etc. (called “inorganic layer”), a composite layer comprising fine inorganic particles and a binder (called “inorganic fine particles-binder composite layer,” or simply “composite layer”), or a resin layer. The dense layer 21 may be made of a material having a refractive index smaller than that of the substrate 1, and larger than the refractive index (1.05-1.35) of the porous silica aerogel layer 22.

Inorganic materials usable for the inorganic layer are magnesium fluoride, calcium fluoride, aluminum fluoride, lithium fluoride, sodium fluoride, cerium fluoride, silicon oxide, aluminum oxide, cryolite, chiolite and these mixtures.

Fine inorganic particles usable for the composite layer are selected from the group consisting of calcium fluoride, magnesium fluoride, aluminum fluoride, sodium fluoride, lithium fluoride, cerium fluoride, silicon oxide, aluminum oxide, zirconium oxide, cryolite, chiolite, titanium oxide, indium oxide, tin oxide, antimony oxide, cerium oxide, hafnium oxide and zinc oxide. The silicon oxide is preferably colloidal silica, which may be surface-treated, for instance, by a silane coupling agent, etc. The refractive index of the fine inorganic particles-binder composite layer depends on the composition and percentage of fine inorganic particles, and the composition of a binder.

The resin layer may be a fluororesin layer, an epoxy resin layer, an acrylic resin layer, a silicone resin layer and a urethane resin layer. The fluororesins are categorized to crystalline fluororesins such as polytetrafluoroethylene, a perfluoroethylene-propylene copolymer, a perfluoroalkoxy resin, polyvinylidene fluoride, an ethylene-tetrafluoroethylene copolymer, polychlorotrifluoroethylene, etc., and amorphous fluororesins. Because of excellent transparency, the amorphous fluororesins are more preferable. Specific examples of the amorphous fluororesins are fluoroolefin copolymers, fluorine-containing cycloaliphatic polymers, and fluorinated acrylic copolymers. The fluoroolefin copolymers may comprise 37-48% by mass of tetrafluoroethylene, 15-35% by mass of vinylidene fluoride, and 26-44% by mass of hexafluoropropylene. The fluorine-containing cycloaliphatic polymers may be polymers of fluorine-containing cycloaliphatic monomers, and cyclic polymers of fluorine-containing monomers having at least two double bonds.

The porous silica aerogel layer 22 preferably has uniformly fine pores with small pore size. Such porous silica aerogel layer 22 has high transparency. The refractive index of the porous silica aerogel layer 22 depends on porosity. The porous silica aerogel layer 22 having a larger porosity has a smaller refractive index. The porosity of the porous layer 22 is preferably 30-90%. The silica aerogel layer having a porosity of 30-90% usually has a refractive index of 1.05-1.35. For instance, the silica aerogel layer of a porosity of 78% has a refractive index of about 1.1. When the porosity is more than 90%, the porous layer 22 has too small mechanical strength. When the porosity is less than 30%, the porous layer 22 has too large a refractive index.

The porous silica aerogel layer 22 has a lot of pores, into which moisture easily enters, making the porous silica aerogel layer 22 hydrophilic with anti-fogging properties. The contact angle of the porous silica aerogel layer 22 to pure water is 15° or less, preferably 12° or less. Moisture entering into the pores provides the porous silica aerogel layer 22 with slightly increased refractive index, though causing substantially no trouble for practical applications. The term “contact angle” used herein means an angle between a tangent line of a water drop at a point in contact with an apparent horizontal surface of the porous silica aerogel layer 22 and the apparent horizontal surface. The contact angle may be measured by a usual contact angle meter, which can measure a stationary water drop on a plate, though not restrictive. The measurement conditions of contact angle are preferably a temperature of 21-24° C., a relative humidity of 45-55%, and a sample amount of 1-10 μL.

The above anti-reflection coating 2 comprising only two layers, a dense layer 21 and a porous silica aerogel layer 22, has excellent anti-reflection characteristics to a wide-incident-angle light in a wide wavelength range from a visible region to an infrared region. The term “excellent anti-reflection characteristics” means small reflectance and large transmittance. Specifically, the anti-reflection coating 2 has a luminous reflectance of 2% or less to light at an incident angle of 0-60° in a desired anti-reflection wavelength range. The term “luminous reflectance” used herein means a Y value determined from the spectral reflectance of the anti-reflection coating according to the XYZ color system of CIE. The Y value is generally represented by the following formula (1):
Y=∫ρ(λ)dλ (1),
wherein λ is a wavelength, and ρ(λ) is a spectral reflectance expressed as a function of the wavelength λ. For instance, when the designed wavelength λd is 550 nm, substantially a center wavelength of the anti-reflection wavelength range of 380-780 nm, a range of a wavelength λ used to determine the Y value by the formula (1) is a predetermined range with λd as a center, for instance, λd±100 nm=450-650 nm, or λd±50 nm=500-600 nm. On the other hand, by determining a wavelength range providing luminous reflectance of 2% or less, whose center wavelength corresponds to the designed wavelength, it is possible to set the optimum optical thickness d₁, d₂ of the dense layer 21 and the porous silica aerogel layer 22. With the designed wavelength λd changed, the anti-reflection wavelength range of the anti-reflection coating 2 can be shifted or widened.
[2] Production Method of Anti-Reflection Coating
(1) Formation of Dense Layer

The layer made only of an inorganic material may be produced by a physical vapor deposition method such as a vacuum vapor deposition method, a sputtering method, an ion plating method, etc., or a chemical vapor deposition method such as a thermal CVD, a plasma CVD, a light CVD, etc. The fine inorganic particles-binder composite layer may be produced by a wet method such as a dip-coating method, a spin-coating method, a spraying method, a roll-coating method, a screen-printing method, etc. The resin layer may be formed by a chemical vapor deposition method or a wet method. Among these methods, the production of the inorganic layer by a vapor deposition method will be explained first, and then the production of the composite layer and the fluororesin layer by a dip coating method will be explained.

(a) Vapor Deposition Method

In the vapor deposition method, an inorganic vapor source is evaporated by heating and deposited onto a substrate in vacuum to form an inorganic layer. Though not particularly restricted, the evaporation of the vapor source may be performed by an electric current-heating method, an electron beam method using an E-type electron gun, a method of irradiating large-current electron beams by hollow cathode discharge, a laser abrasion method using laser pulse, etc. The substrate is preferably rotated during vapor deposition while keeping its surface to be coated opposite to the vapor source. With properly designed vapor deposition time, heating temperature, etc., the layer having desired thickness can be formed.

(b) Dip-Coating Method

(b-1) Fine Inorganic Particles-Binder Composite Layer

(i) Preparation of Slurry Containing Fine Inorganic Particles

The fine inorganic particles preferably have an average particle size of about 5-80 nm. When the average particle size is more than 80 nm, the resultant anti-reflection coating has poor transparency. It is difficult to produce fine inorganic particles having an average particle size of less than 5 nm.

The mass ratio of fine inorganic particles to the binder component is preferably 0.05-0.7. When the mass ratio is more than 0.7, the slurry cannot easily be coated uniformly, and a brittle layer is formed. When the mass ratio is less than 0.05, it is not easy to provide the dense layer with a desired refractive index.

The term “binder component” used herein means a monomer or an oligomer, which becomes a binder by polymerization. The binder component is preferably an ultraviolet-curable or thermosetting compound, more preferably an ultraviolet-curable compound. Using an ultraviolet-curable compound, a binder-containing anti-reflection coating can be formed even if the substrate does not have heat resistance. The ultraviolet-curable or thermosetting compounds may be radically polymerizable compounds, cationically polymerizable compounds, and anionically polymerizable compounds. These compounds may be used in combination.

The radically polymerizable compounds are preferably acrylates. Specific examples of the radically polymerizable compounds are (a) mono-functional (meth)acrylates such as 2-hydroxy ethyl(meth)acrylate, 2-hydroxy propyl(meth)acrylate, hydroxy butyl(meth)acrylate, 2-hydroxy -3-phenoxypropyl(meth)acrylate, carboxypolycaprolactone(meth)acrylate, (meth)acrylic acid, (meth)acrylamide; (b) poly-functional(meth)acrylates such as (i) di(meth)acrylates such as pentaerythritol di(meth)acrylate, ethylene glycol di(meth)acrylate and pentaerythritol di(meth)acrylate monostearate; (ii) tri(meth)acrylates such as trimethylolpropane tri(meth)acrylate and pentaerythritol tri(meth)acrylate; (iii) tetra(meth)acrylates such as pentaerythritol tetra(meth)acrylate; (iv) penta(meth)acrylates such as dipentaerythritol penta(meth)acrylate; and (c) oligomers obtained by polymerizing these monomers, etc.

The cationically polymerizable compounds are preferably epoxy compounds. Specific examples of the cationically polymerizable compounds are phenylglycidyl ether, ethylene glycol diglycidyl ether, glycerin diglycidyl ether, vinylcyclohexene dioxide, 1,2,8,9-diepoxy limonene, 3,4-epoxycyclohexylmethyl 3′,4′-epoxy cyclohexane carboxylate and bis(3,4-epoxy cyclohexyl) adipate.

When the radically polymerizable compound or the cationically polymerizable compound is used as the binder component, the slurry containing fine inorganic particles preferably comprises a radical polymerization initiator or a cationic polymerization initiator. The radical polymerization initiator may be a compound generating radicals by ultraviolet irradiation. The preferred radical polymerization initiators are benzyls, benzophenones, thioxanthones, benzyl dimethyl ketals, α-hydroxy alkyl phenones, hydroxyketones, amino alkyl phenones and acyl phosphine oxides. The amount of the radical polymerization initiator added is preferably about 0.1-20 parts by mass per 100 parts by mass of the radically polymerizable compound.

The cationic polymerization initiator may be a compound generating cations by ultraviolet irradiation. Examples of the cationic polymerization initiators are onium salts such as diazonium salts, sulphonium salts, iodonium salts, etc. The amount of the cationic polymerization initiator added is preferably about 0.1-20 parts by mass per 100 parts by mass of the cationically polymerizable compound.

2 or more types of the fine inorganic particles and 2 or more types of the binder components may respectively be added to the slurry. A usual additive such as a dispersing agent, a stabilizing agent, a viscosity-adjusting agent, a coloring agent, etc., may be added within a range not deteriorating the properties of the resultant layer.

The concentration of the slurry affects the thickness of the layer. Examples of usable solvents are alcohols such as methanol, ethanol, n-propyl alcohol, i-propyl alcohol, n-butyl alcohol, 2-butyl alcohol, i-butyl alcohol, t-butyl alcohol, etc.; alkoxy alcohols such as 2-ethoxy ethanol, 2-butoxyethanol, 3-methoxy propanol, 1-methoxy-2-propanol, 1-ethoxy -2-propanol, etc.; ketols such as diacetone alcohol, etc.; ketones such as acetone, methyl ethyl ketone, methyl i-butyl ketone, etc.; aromatic hydrocarbons such as toluene, xylene, etc.; esters such as ethyl acetate, butyl acetate, etc. The amount of the solvent used is preferably about 20-10,000 parts by mass per the total (100 parts by mass) of the fine inorganic particles and the binder component.

(ii) Coating

A layer of a slurry containing fine inorganic particles is formed on the substrate by a dip-coating method, a spin-coating method, a spraying method, a roll-coating method, a screen-printing method, etc. For instance, in the case of the dip-coating method, the thickness of the formed layer can be controlled by the concentration of the slurry, immersion time, take-up speed, etc.

The binder component in the slurry layer containing fine inorganic particles is polymerized. In the case of the ultraviolet-curable binder component, it is polymerized by UV irradiation at about 50-3,000 mJ/cm² to form a layer comprising the fine inorganic particles and the binder. Though depending on the thickness of the layer, the irradiation time is usually about 0.1-60 seconds. A solvent is evaporated from the slurry layer. The evaporation of a solvent may be carried out at room temperature or at about 30-100° C.

(b-2) Fluororesin Layer

(i) Preparation of Fluorine-Containing Composition Solution

The fluororesin layer may be formed by (a) cross-linking a composition comprising a fluorine-containing olefin polymer and a cross-linkable compound applied in the form of a solution to the substrate, or

(b) copolymerizing a composition comprising a fluorine-containing olefinic compound, a comonomer, etc. applied in the form of a solution to the substrate. The methods of forming a fluororesin layer by using a fluorine-containing composition are described in detail in JP 07-126552A, JP 11-228631A, JP 11-337706A, etc.

A commercially available fluorine-containing composition may be mixed with an appropriate solvent. Examples of usable fluorine-containing compositions are OPSTAR available from JSR Corporation, CYTOP available from Asahi Glass Co., Ltd. The preferred solvents are ketones such as methylethylketone, methyl i-butyl ketone and cyclohexanone; esters such as ethyl acetate and butyl acetate, etc. The fluorine-containing olefin polymer and the fluorine-containing olefinic compound are preferably at a concentration of 5-80% by mass.

(ii) Coating

Because the fluororesin layer is formed substantially in the same manner as the composite layer described in (b-1) above except for using a solution of a fluorine-containing composition, explanation will be focused on their differences. After forming a layer of a solution of a fluorine-containing composition, cross-linking or polymerization is carried out. When the cross-linkable compound or the fluorine-containing olefinic compound is thermosetting, the layer is preferably heated at 100-140° C. for about 30-60 minutes. In the case of the ultraviolet-curable compound, UV irradiation is carried out at about 50-3,000 mJ/cm². Though depending on the thickness of the layer, the irradiation time is usually about 0.1-60 seconds.

(2) Formation of Porous Silica Aerogel Layer

The porous silica aerogel layer can be formed by (a) reacting a silicon oxide sol or gel with an organic-modifying agent to form an organic-modified sol or gel, (b) applying said organic-modified sol or a sol formed from said organic-modifying gel to a dense layer surface, (c) causing a springback phenomenon in the resultant organically modified silica gel layer to turn it to an organic-modified silica aerogel layer, and (d) heat-treating the organic-modified silica aerogel layer to remove an organic-modifying group.

(a) Starting Materials for Silica Aerogel Layer

(a-1) Alkoxy Silane and Silsesquioxane

An alkoxysilane and/or a silsesquioxane are hydrolyzed and polymerized to form a silica sol and a silica gel. The alkoxysilane may be in the form of a monomer or an oligomer. The alkoxysilane monomer preferably has 3 or more alkoxyl groups. The use of the alkoxysilane having 3 or more alkoxyl groups as a starting material can provide an anti-reflection coating having excellent uniformity. Specific examples of the alkoxysilane monomers are methyltrimethoxysilane, methyltriethoxysilane, phenyltriethoxysilane, tetramethoxysilane, tetraethoxysilane, tetrabutoxysilane, tetrapropoxysilane, diethoxydimethoxysilane, dimethyldimethoxysilane, and dimethyldiethoxysilane. The alkoxysilane oligomer is preferably a polycondensate of the above monomer. The alkoxysilane oligomer can be obtained by the hydrolysis and polymerization of the alkoxysilane monomer.

The use of a silsesquioxane as a starting material can also provide an anti-reflection coating with excellent uniformity. The silsesquioxane is a general name of polysiloxanes in the form of network, which are represented by the general formula: RSiO_{1.5}, wherein R represents an organic functional group. R may be, for instance, a linear or branched alkyl group having 1-6 carbon atoms, a phenyl group, or an alkoxy group (for instance, methoxy group, ethoxy group, etc.). It is known that the silsesquioxane has various structures such as a ladder structure, a cage structure, etc. It has excellent weather resistance, transparency and hardness, suitable as a starting material for the silica aerogel.

(a-2) Solvent

The solvent is preferably a mixture of water or an alcohol. The alcohol is preferably methanol, ethanol, n-propyl alcohol or i-propyl alcohol, particularly ethanol. A water/alcohol molar ratio in the solvent is preferably 0.01-2. When the water/alcohol molar ratio is more than 2, a hydrolysis reaction proceeds too rapidly. When the water/alcohol molar ratio is less than 0.01, the hydrolysis of an alkoxysilane and/or a silsesquioxane (simply called as “alkoxysilane, etc.”) does not occur sufficiently.

(a-3) Catalyst

An aqueous solution of the alkoxysilane, etc. preferably contains a catalyst. An appropriate catalyst accelerates the hydrolysis of the alkoxysilane, etc. The catalyst may be acidic or basic. Examples of the acidic catalyst are hydrochloric acid, nitric acid and acetic acid. Examples of the basic catalyst are ammonia, amines, NaOH and KOH. Preferred examples of the amines are alcohol amines, alkyl amines (for instance, methylamine, dimethylamine, trimethylamine, n-butylamine, n-propylamine).

(b) Production of Sol or Gel

The alkoxysilane, etc. is dissolved in a solvent consisting of water and an alcohol. The molar ratio of the solvent to the alkoxysilane, etc. is preferably 3-100. When the solvent/alkoxysilane, etc. molar ratio is less than 3, the degree of polymerization of the alkoxysilane, etc. is too high. When the solvent/alkoxysilane, etc. molar ratio is more than 100, the degree of polymerization of the alkoxysilane, etc. is too low. The molar ratio of the catalyst to the alkoxysilane, etc. is preferably 1×10⁻⁴ to 3×10⁻², more preferably 3×10⁻⁴ to 1×10⁻². When the catalyst/alkoxysilane, etc. molar ratio is less than 1×10⁻⁴, the hydrolysis of the alkoxysilane, etc. does not occur sufficiently. When the catalyst/alkoxysilane, etc. molar ratio is more than 3×10⁻², there is no sufficient catalytic effect.

A solution containing the alkoxysilane, etc. is aged for about 20-60 hours. The aging is specifically carried out by leaving the solution to stand or slowly stirring it at 25-90° C. Gelation proceeds by aging to form a sol or gel containing silicon oxide. The “sol containing silicon oxide” includes a dispersion of silicon oxide colloid particles, or a dispersion of sol clusters composed of agglomerated colloid particles.

(c) Organic Modification

The sol or gel is sufficiently mixed with an organic-modifying agent solution, to replace a hydrophilic group such as a hydroxy group, etc. at the ends of silicon oxide constituting the sol or gel with a hydrophobic organic group. The preferred organic-modifying agents are compounds represented by the following formulae (2)-(7):
MₚSiCl_{q} (2),
M₃SiNHSiM₃ (3),
MₚSi(OH)_{q} (4),
M₃SiOSiM₃ (5),
MₚSi(OM)_{q} (6), or
MₚSi(OCOCH₃)_{q} (7),
wherein p is an integer of 1-3, q is an integer of 1-3 satisfying q=4−p, M is hydrogen, a substituted or unsubstituted alkyl group having 1-18 carbon atoms, or a substituted or unsubstituted aryl group having 5-18 carbon atoms, or mixtures of these compounds.

Specific examples of the organic-modifying agents are triethylchlorosilane, trimethylchlorosilane, diethyldichlorosilane, dimethyldichlorosilane, acetoxytrimethylsilane, acetoxysilane, diacetoxydimethylsilane, methyltriacetoxysilane, phenyltriacetoxysilane, diphenyldiacetoxysilane, trimethylethoxysilane, trimethylmethoxysilane, 2-trimethyl siloxypent-2-en-4-on, n-(trimethylsilyl) acetamide, 2-(trimethylsilyl) acetate, n-(trimethylsilyl) imidazole, trimethylsilylpropiolate, nonamethyltrisilazane, hexamethyldisilazane, hexamethyldisiloxane, trimethylsilanol, triethylsilanol, triphenylsilanol, t-butyldimethylsilanol, and diphenylsilanediol.

Solvents for the organic-modifying agent solution may be hydrocarbons such as hexane, cyclohexane, pentane, heptane, etc.; alcohols such as methanol, ethanol, n-propyl alcohol, i-propyl alcohol, etc.; ketones such as acetone, etc.; aromatics such as benzene, toluene, etc.

The organic-modifying reaction is preferably conducted at 10-40° C., though variable depending on the type and concentration of the organic-modifying agent. When the organic-modifying temperature is lower than 10° C., the organic-modifying agent does not easily react with silicon oxide. When it is higher than 40° C., the organic-modifying agent easily reacts with other substances than silicon oxide. The solution is preferably stirred to avoid a distribution in temperature and concentration in the solution during the reaction. For instance, when the organic-modifying agent solution is a solution of triethylchlorosilane in hexane, holding at 10-40° C. for about 20-40 hours (for instance, 30 hours) sufficiently modifies a silanol group with a silyl group. The modification ratio is preferably 10-30%.

(d) Substitution of Solvent

The solvent (dispersing medium) in the sol or gel is preferably replaced by another high-dispersing solvent before or after the organic modification, to improve the dispersibility of the sol or gel. In the case of the gel, an operation comprising introducing the high-dispersing solvent into a vessel containing the gel, vibrating the vessel and decanting the solvent is preferably repeated. Because the solvent in the gel is usually water plus ethanol, it is preferable to replace a mixed solvent of water and ethanol with ethanol, and then replace ethanol with another high-dispersing solvent such as a ketone. In the case of the sol, it is preferable to add a low-boiling-point solvent azeotropic to the solvent in the sol, remove the original solvent by azeotropy, and then introduce a high-dispersing solvent as a new solvent. The azeotropic solvent may be the same as or different from the high-dispersing solvent.

The high-dispersing solvent is preferably water, ethanol, methanol, propanol, butanol, hexane, heptane, pentane, cyclohexane, toluene, acetonitrile, acetone, dioxane, methyl i-butyl ketone, propylene glycol monomethyl ether, ethylene glycol monomethyl ether, ethyl acetate or a mixture thereof, more preferably ketones.

When the solvent is substituted with a ketone before an ultrasonic treatment step described later, it is possible to obtain an organic-modified-silica-containing sol with good dispersibility. The ketone has excellent affinity for silica (silicon oxide) and the organic-modified silica. Thus, silica and the organic-modified silica are well dispersed in a ketone solvent. Substitution with a ketone may be conducted before the organic-modifying reaction, or after silicon oxide is organically modified with a solvent such as hexane, etc. To reduce the number of steps, the substitution is preferably conducted before the organic-modifying reaction.

The ketone solvent preferably has a boiling point of 60° C. or higher. A ketone with a boiling point of lower than 60° C. is too evaporated in an ultrasonic irradiation step described later. For instance, when acetone is used as a dispersing medium, acetone is evaporated too much during the ultrasonic irradiation, making it difficult to control the concentration of the dispersion. It also quickly evaporates in a film-forming step, resulting in insufficient film-forming time. Further, acetone is harmful to humans, not suitable for from the aspect of operators' health.

Particularly preferable ketones are unsymmetrical ketones having different substituents on both sides of carbonyl groups. Because the unsymmetrical ketones have large polarity, they have excellent affinity for silica and the organic-modified silica.

The ketone may have a substituent such as an alkyl or aryl group. The preferred alkyl groups have about 1-5 carbon atoms. Specific examples of the ketones are methyl i-butyl ketone, ethyl i-butyl ketone, and methyl ethyl ketone.

(e) Ultrasonic Treatment

An ultrasonic treatment makes the organic-modified silicon oxide gel or sol suitable for coating. In the case of the organic-modified silicon oxide gel, the ultrasonic treatment dissociates a gel coagulated by an electric force or a van der Waals force, and destroys covalent bonds of metals to oxygen, resulting in a dispersed gel. In the case of the sol, too, the ultrasonic treatment reduces the agglomeration of colloid particles. The ultrasonic treatment can be conducted by a dispersing apparatus using an ultrasonic vibrator. An ultrasonic radiation frequency is preferably 10-30 kHz, and an output is preferably 300-900 W.

The ultrasonic treatment time is preferably 5-120 minutes. Longer ultrasonic irradiation results in finer pulverization of clusters of the gel or the sol, resulting in less agglomeration. Accordingly, colloid particles of organic-modified silicon oxide are almost in a single dispersion state in the silica-containing sol obtained by the ultrasonic treatment. When the ultrasonic treatment time is shorter than 5 minutes, the colloid particles are not sufficiently dissociated. Even if the ultrasonic treatment time were longer than 120 minutes, the dissociation of the colloid particles of the organic-modified silicon oxide would not substantially change.

In the organic-modified-silica-containing sol thus obtained, the organic-modified silica preferably has a particle size of 200 nm or less. When the organic-modified silica is larger than 200 nm, it is difficult to form a substantially smooth silica aerogel film.

The above organic solvent may be added as a dispersing medium before or in the course of the ultrasonic treatment, such that the organic-modified-silica-containing sol has proper concentration and fluidity. The solvent may be added the ultrasonic treatment is conducted to some extent. A mass ratio of the organic-modified silicon oxide to the solvent is preferably 0.1-20%. Outside this mass ratio range, it is difficult to form a uniform thin film.

(f) Coating

An organic-modified-silica-containing sol is coated on the dense layer. The coating of the organic-modified-silica-containing sol may be conducted by a spray-coating method, a spin-coating method, a dip-coating method, a flow-coating method, a bar-coating method, etc. A solvent is evaporated from the coated organic-modified-silica-containing sol to form an organic-modified silica aerogel layer. Though the organic-modified silica aerogel layer has a porosity reduced by the shrinkage of the gel due to capillary pressure during the evaporation of the dispersing medium, the porosity is recovered by a springback phenomenon after the completion of evaporation. Thus, the porosity of the organic-modified silica aerogel layer is substantially as large as the original one of the gel network. The shrinkage of a silica gel network and the springback phenomenon are described in U.S. Pat. No. 5,948,482 in detail.

The use of a sol containing silicon oxide colloid particles having nearly single dispersion can form the organic-modified silica aerogel layer with small porosity. On the other hand, the use of a sol containing largely agglomerated colloid particles can form the organic-modified silica aerogel layer with large porosity. Thus, the ultrasonic treatment time influences the porosity of the organic-modified silica aerogel layer and the silica aerogel layer obtained by heat-treating it. The dip coating of the sol ultrasonic-treated for 5-120 minutes can provide the organic-modified silica aerogel layer with a porosity of 30-90%.

(g) Heat Treatment

The resultant porous, organic-modified silica aerogel layer is heat-treated to remove organic-modifying groups. The heat treatment temperature is preferably a temperature of detaching the organic-modifying groups or higher, and the glass transition temperature of the substrate or lower. When the heat treatment temperature is higher than the glass transition temperature of the substrate, the substrate is deformed. The upper limit of the heat treatment temperature is preferably the glass transition temperature of the substrate—100° C. or lower. Specifically, when the heat treatment temperature is higher than 150° C., it is possible to sufficiently decompose organic groups, thereby obtaining a hydrophilic silica aerogel layer. The heat treatment temperature is preferably 300° C. or higher, more preferably 400° C. or higher.

The heat treatment time is preferably in a range of 10 minutes to 4 hours. Such heat treatment can sufficiently remove organic-modifying groups from the organic-modified, porous silica aerogel layer. The removal of organic groups turns the silica aerogel layer hydrophilic, thereby making it easy for water to enter into its pores. Also, because the heat treatment makes the bonding of particles constituting the silica aerogel stronger, the aerogel layer has improved scratch resistance. Accordingly, the formation of the hydrophilic, porous silica aerogel layer provides the anti-reflection coating with anti-fogging properties and scratch resistance.

The present invention will be explained in more detail referring to Examples below without intention of restricting the present invention thereto.

### EXAMPLE 1

An anti-reflection coating was formed on a flat BK7 glass plate by the steps (1) and (2) below. The designed wavelength λd was 550 nm.

(1) Formation of Dense Layer

Using an apparatus with an electron-beam vapor deposition source, a magnesium fluoride layer (refractive index: 1.38) having a physical thickness of 94 nm (optical thickness: 130 nm) was formed on a flat BK7 glass plate having a refractive index of 1.518 at a wavelength of 550 nm by a vapor deposition method.

(2) Formation of Porous Layer

(i) Preparation of Organic-Modified-Silica-Containing Sol

After 5.21 g of tetraethoxysilane was mixed with 4.38 g of ethanol, 0.4 g of hydrochloric acid (0.01 N) was added thereto, and the resultant mixture was stirred for 90 minutes. After 44.3 g of ethanol and 0.5 g of an aqueous ammonia solution (0.02 N) were added, the resultant mixture was stirred for 46 hours. This mixed liquid was aged at 60° C. for 46 hours to form a wet gel. After decanting the solvent, ethanol was quickly added, and the wet gel was vibrated. The solvent in the wet gel was replaced by ethanol by decantation. The wet gel was further vibrated with methyl isobutyl ketone (MIBK) added. Ethanol as a solvent in the wet gel was then replaced by MIBK by decantation. The silica gel was mixed with a solution of trimethylchlorosilane in MIBK (concentration: 5% by volume), and stirred for 20 hours for organic modification of silicon oxide at ends. The resultant organically modified silica gel was washed with isopropyl alcohol (IPA). After IPA was added to the organically modified silica gel to a concentration of 10% by mass, the silica gel was turned to sol by ultrasonic irradiation (20 kHz, 500 W) for 40 minutes.

(ii) Dip Coating

The dense magnesium fluoride layer obtained in the above step (1) was dip-coated with the organic-modified-silica-containing sol obtained in the above step (2) to a physical thickness of 145 nm, air-dried at room temperature, and heat-treated at 150° C. for 1 hour to form a porous, organic-modified silica aerogel layer.

(iii) Hydrophilic Treatment

The flat glass plate provided with the porous, organic-modified silica aerogel layer was heat-treated at 450° C. for 1 hour to form a hydrophilic, porous silica aerogel layer. The resultant porous silica aerogel layer had a refractive index of 1.20 and a physical thickness of 115 nm (optical thickness: 138 nm). The layer structure and characteristics of the resultant anti-reflection coating are shown in Table 1.

TABLE 1

| Layer | | Porosity | Refractive | Optical |
|---|---|---|---|---|
| Structure | Composition | (%) | Index | Thickness (nm) |
| Dense Layer | MgF₂ | — | 1.38 | 130 |
| Porous | Silica Aerogel | 57 | 1.20 | 138 |
| Layer | | | | |

### EXAMPLE 2

A multi-layer anti-reflection coating was formed on a flat LAK14 glass plate by the steps (1) and (2) below. The designed wavelength λd was 550 nm.

(1) Formation of Dense Layer

Using an apparatus with an electron-beam vapor deposition source, a silicon oxide layer (refractive index: 1.46) having a physical thickness of 90 nm (optical thickness: 131 nm) was formed on a flat LAK14 glass plate having a refractive index of 1.697 at a wavelength of 550 nm by a vapor deposition method.

(2) Formation of Porous Layer

(i) Preparation of Organic-Modified-Silica-Containing Sol

An organic-modified-silica-containing sol was prepared in the same manner as in Example 1, except that an organic-modifying treatment was conducted by a solution of trimethylchlorosilane in MIBK for 40 hours, and that ultrasonic irradiation was conducted for 20 minutes.

(ii) Dip Coating

The silicon oxide layer obtained in the above step (1) was dip-coated with the organic-modified-silica-containing sol obtained in the above step (2) to a physical thickness of 145 nm, air-dried at room temperature, and heat-treated at 150° C. for 1 hour to form a porous, organic-modified silica aerogel layer.

(iii) Hydrophilic Treatment

The flat glass plate provided with the porous, organic-modified silica aerogel layer was heat-treated at 450° C. for 1 hour to form a hydrophilic, porous silica aerogel layer. The resultant porous silica aerogel layer had a refractive index of 1.15 and a physical thickness of 115 nm (optical thickness: 132 nm). The layer structure and characteristics of the resultant anti-reflection coating are shown in Table 2.

TABLE 2

| Layer | | Porosity | Refractive | Optical |
|---|---|---|---|---|
| Structure | Composition | (%) | Index | Thickness (nm) |
| Dense | SiO₂ | — | 1.46 | 131 |
| Layer | | | | |
| Porous | Silica Aerogel | 67 | 1.15 | 132 |
| Layer | | | | |

### COMPARATIVE EXAMPLE 1

An anti-reflection coating consisting only of dense layers was formed on a flat BK7 glass plate by a vapor deposition method in the same manner as in the step (1) in Example 1. The layer structure and characteristics of the resultant dense anti-reflection coating are shown in Table 3.

TABLE 3

| | | | Physical | Optical |
|---|---|---|---|---|
| Structure of | | Refractive | Thickness | Thickness |
| Dense Layer | Composition | Index | (nm) | (nm) |
| 1st Layer | SiO₂ | 1.46 | 86 | 126 |
| 2nd Layer | Al₂O₃ | 1.64 | 76 | 125 |
| 3rd Layer | ZrO₂ | 2.0 | 122 | 244 |
| 4th Layer | MgF₂ | 1.38 | 90 | 124 |

### COMPARATIVE EXAMPLE 2

A anti-reflection coating consisting only of dense layers having the structure shown in Table 4 was formed on an SF5 glass plate having a refractive index of 1.68 at a wavelength of 550 nm as a substrate in the same manner as in the step (1) in Example 1, except that silicon oxide and titanium oxide were alternately laminated by a vapor deposition method. The layer structure and characteristics of the resultant dense anti-reflection coating are shown in Table 4.

TABLE 4

| | | | Physical | Optical |
|---|---|---|---|---|
| Structure of | | Refractive | Thickness | Thickness |
| Dense Layer | Composition | Index | (nm) | (nm) |
| 1st Layer | SiO₂ | 1.46 | 34 | 50 |
| 2nd Layer | TiO₂ | 2.347 | 14 | 33 |
| 3rd Layer | SiO₂ | 1.46 | 30 | 44 |
| 4th Layer | TiO₂ | 2.347 | 112 | 263 |
| 5th Layer | SiO₂ | 1.46 | 86 | 126 |

### COMPARATIVE EXAMPLE 3

An anti-reflection coating consisting only of dense layers was formed on a flat BK7 glass plate by a vapor deposition method in the same manner as in the step (1) in Example 1. The layer structure and characteristics of the resultant dense anti-reflection coating are shown in Table 5.

TABLE 5

| | | | Physical | Optical |
|---|---|---|---|---|
| Structure of | | Refractive | Thickness | Thickness |
| Dense Layer | Composition | Index | (nm) | (nm) |
| 1st Layer | SiO₂ | 1.46 | 188 | 274 |
| 2nd Layer | Al₂O₃ | 1.64 | 72 | 118 |
| 3rd Layer | Ta₂O₅ | 2.25 | 16 | 36 |
| 4th Layer | Al₂O₃ | 1.64 | 13 | 21 |
| 5th Layer | Ta₂O₅ | 2.25 | 108 | 243 |
| 6th Layer | Al₂O₃ | 1.64 | 32 | 52 |
| 7th Layer | Ta₂O₅ | 2.25 | 16 | 36 |
| 8th Layer | MgF₂ | 1.38 | 96 | 132 |

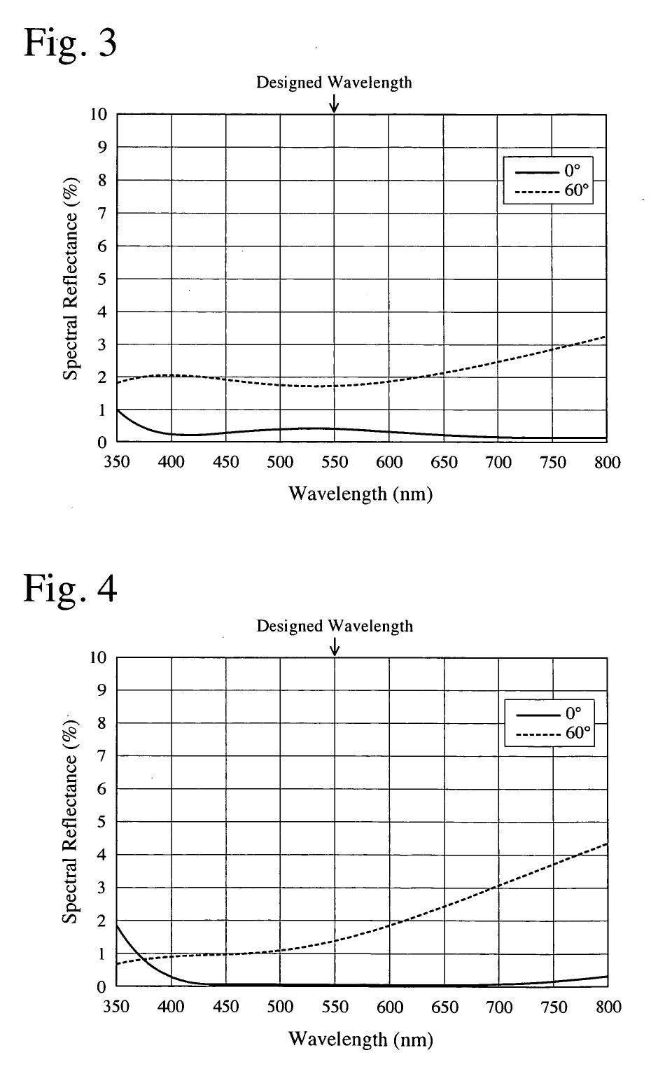

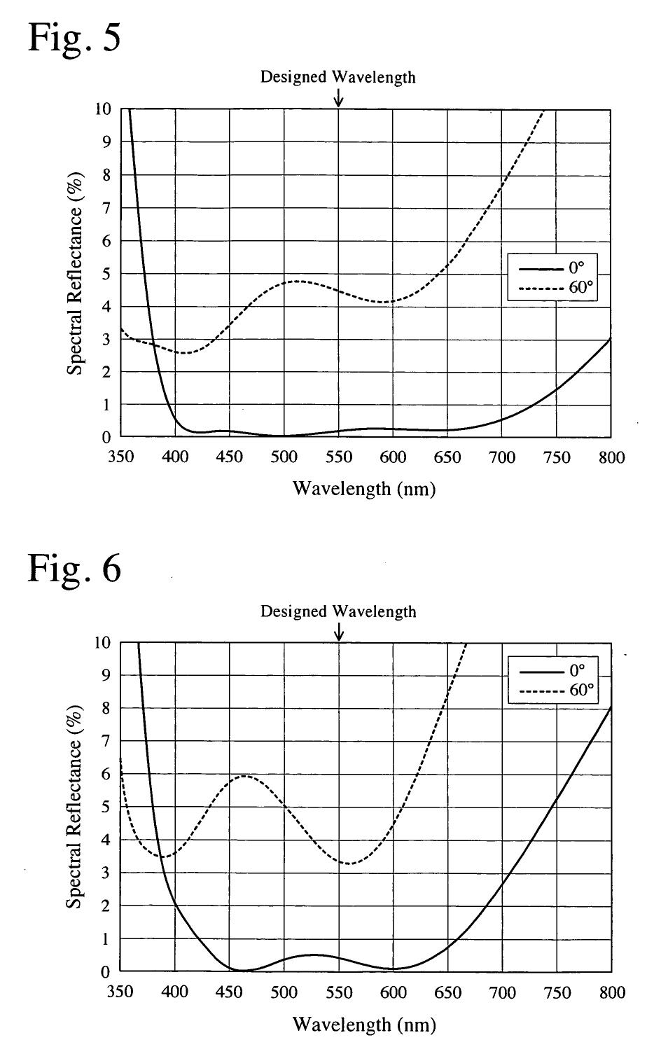

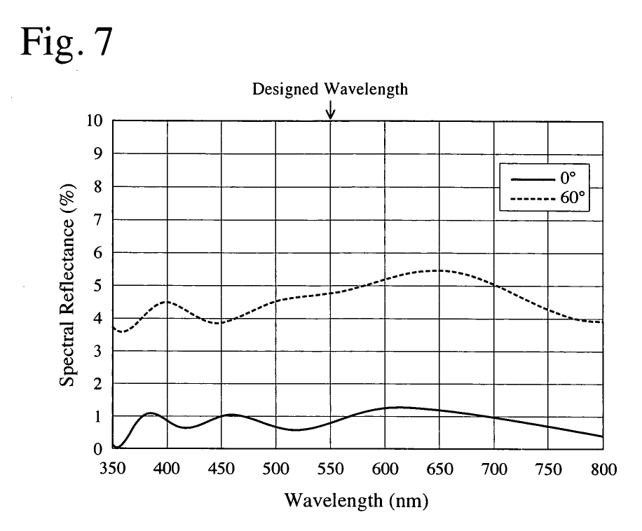

With respect to the anti-reflection coatings of Examples 1 and 2 and Comparative Examples 1-3, spectral reflectance of light in a wavelength range of 350 nm to 800 nm was measured at incident angles of 0° and 60°, respectively, using a spectrophotometer U4000 available from Hitachi, Ltd. The results are shown in FIGS. 3-7. In Examples 1 and 2, the spectral reflectance was 2% or less at an incident angle of 0°, and 5% or less at an incident angle of 60°. On the other hand, the multi-layer anti-reflection coatings consisting only of dense layers in Comparative Examples 1-3 had much poorer spectral reflectance to light at both incident angles of 0° and 60°.

A luminous reflectance (Y value in the XYZ color system of CIE) was determined from the resultant spectral reflectance. The results are shown in Table 6.

Each anti-reflection coating of Examples 1 and 2 was observed after it was rubbed 5 times with a water-wetted nonwoven fabric BEMCOT® (Lint Free® wiper) available from Asahi Kasei Corporation. Also, pure water was dropped onto each anti-reflection coating of Examples 1 and 2 to measure a contact angle. The results are shown in Table 6.

TABLE 6

| | Luminous Reflectance (%) | | | |
|---|---|---|---|---|
| | to Light at | | | |
| | Incident | Incident | Scratch | Contact |
| No. | Angle of 0° | Angle of 60° | Resistance | Angle (°) |
| Example 1 | 0.4 | 1.8 | No Scratch | 7 |
| Example 2 | 0.0 | 1.5 | No Scratch | 9 |
| Comparative | 0.2 | 4.5 | — | — |
| Example 1 | | | | |
| Comparative | 0.4 | 4.0 | — | — |
| Example 2 | | | | |
| Comparative | 0.8 | 4.8 | — | — |
| Example 3 | | | | |

As is clear from Table 6, the luminous reflectance was less than 2% to light at both incident angles of 0° and 60° in Examples 1 and 2, while it was 4% or more to light at an incident angle of 60° in Comparative Examples 1-3 each having a dense multi-layer anti-reflection coating. The anti-reflection coatings of Examples 1 and 2 had excellent scratch resistance, because no scars were observed after rubbed with a water-wetted lint-free wiper 5 times. The anti-reflection coatings of Examples 1 and 2 had a contact angle of 15° or less to pure water, indicating excellent hydrophilicity.

### EFFECT OF THE INVENTION

Because the anti-reflection coating of the present invention comprises a dense layer and a porous silica aerogel layer formed in this order on a substrate such that a refractive index successively decreases from said substrate to said porous layer, it has excellent anti-reflection characteristics to a wide-incident-angle light in a wide wavelength range, and sufficient mechanical strength. When the anti-reflection coating of the present invention having such excellent anti-reflection characteristics is formed on a lens, it is possible to extremely reduce difference in the amount and color of transmitted light between center and peripheral portions of the lens, and the resultant optical element is substantially free from ghost caused by light reflected from the peripheral portion of the lens, etc. When the optical element having such excellent properties is used for cameras, endoscopes, binoculars, projectors, etc., their quality of image can be extremely improved. Particularly because the anti-reflection coating of the present invention has a porous silica aerogel layer having a lot of pores and hydrophilicity as an outermost layer, it exhibits excellent anti-fogging properties. Further, the anti-reflection coating of the present invention comprising two layers can be produced at a low cost with a high yield.

The present disclosure relates to subject matter contained in Japanese Patent Application No. 2005-002774 filed on Jan. 7, 2005, which is expressly incorporated herein by reference in its entirety.

What is claimed is:

1. An anti-reflection coating comprising a dense layer and a porous silica aerogel layer formed in this order on a substrate such that a refractive index successively decreases from said substrate to said porous silica aerogel layer.

2. The anti-reflection coating according to claim 1, wherein said dense layer is an inorganic layer, a fine inorganic particles-binder composite layer or a resin layer.

3. The anti-reflection coating according to claim 2, wherein said inorganic layer is formed by a vapor deposition method.

4. The anti-reflection coating according to claim 3, wherein said vapor-deposited inorganic layer is made of magnesium fluoride or silicon oxide.

5. The anti-reflection coating according to claim 1, wherein said porous silica aerogel layer is formed by heat-treating an organic-modified silica aerogel layer.

6. The anti-reflection coating according to claim 1, wherein said porous silica aerogel layer has a refractive index of 1.05-1.35.

7. The anti-reflection coating according to claim 1, wherein said porous silica aerogel layer has a porosity of 30-90%.

8. The anti-reflection coating according to claim 1, wherein said porous silica aerogel layer has a contact angle of 15° or less to pure water.

9. The anti-reflection coating according to claim 1, wherein said dense layer and said porous silica aerogel layer respectively have optical thickness in a range of λd/5−λd/3, wherein λd is a designed wavelength.

10. The anti-reflection coating according to claim 1, wherein said anti-reflection coating has a luminous reflectance of 2% or less to light at an incident angle of 0-60° in a wavelength range of said designed wavelength λd±100 nm.

11. An optical element for image sensors, which comprises an anti-reflection coating comprising a dense layer and a porous silica aerogel layer formed in this order on a substrate such that a refractive index successively decreases from said substrate to said porous silica aerogel layer.
